(19) United States
(12) Patent Application Publication
(10) Pub. No.: US 2006/0133090 A1
(43) Pub. Date: Jun. 22, 2006

(54) Backlight system and liquid crystal display employing the same

(76) Inventors: Ji-whan Noh, Suwon-si (KR); Jin-gil Jeong, Seoul (KR)

Correspondence Address: STANZIONE & KIM, LLP, 919 18TH STREET, N.W., SUITE 440, WASHINGTON, DC, 20006, US

(21) Appl. No.: 11/296,227

(22) Filed: Dec. 8, 2005

(30) Foreign Application Priority Data
Dec. 20, 2004 (KR) 2004-108807

(51) Int. Cl. F21V 29/00

(52) U.S. Cl. 362/294

(57) ABSTRACT

A backlight system usable in a display positionable in an upright manner, and an LCD employing the backlight system. The backlight system includes a plurality of light emitting device arrangement lines, each line including a plurality of light emitting devices, and a plurality of heat pipes each mounted along one of the plurality of light emitting device arrangement lines, and the plurality of light emitting device arrangement lines and the corresponding mounted heat pipe form a predetermined angle with respect to a horizontal direction such that a movement of working fluid condensed in the heat pipe is accelerated by gravity.

### CROSS-REFERENCE TO RELATED APPLICATIONS

This application claims priority under 35 U.S.C. §119 from Korean Patent Application No. 2004-108807, filed on Dec. 20, 2004, in the Korean Intellectual Property Office, the disclosure of which is incorporated herein in its entirety by reference.

### BACKGROUND OF THE INVENTION

1. Field of the Invention

The present general inventive concept relates to a backlight system and a liquid crystal display employing the same, and more particularly, to a direct light type backlight system and a liquid crystal display employing the same.

2. Description of the Related Art

A liquid crystal display (LCD), which is a type of flat panel display, is a passive display that forms an image using incident light from an external source (i.e., without self-luminescence). A backlight system is disposed at a rear side of the LCD to illuminate toward a liquid crystal panel of the LCD.

The backlight system may be classified as a direct light type backlight system in which light emitted from a plurality of light sources disposed behind a liquid crystal panel propagates toward the liquid crystal panel, or an edge light type backlight system in which light emitted from a light source disposed on a sidewall of a light guide panel is transmitted to the liquid crystal panel. The direct light type backlight system may use light emitting diodes, which emit Lambertian light as point light sources.

In the case of the direct light type backlight system using the light emitting diodes, a plurality of light emitting diodes are arranged in a 2-dimentional array. In particular, the plurality of light emitting diodes are arranged to form two or more lines, each line including a subset of the plurality of light emitting diodes arranged in a series.

The plurality of light emitting diodes generate a significant amount of heat. When a temperature around the direct light type backlight system increases due to the generated heat, an amount and a wavelength of the light emitted from the plurality of light emitting diodes are varied, so that a brightness and a color of the backlight system are altered.

The direct light type backlight system employs a heat radiation device to dissipate the heat generated by the plurality of light emitting diodes. One heat sink, one fan, and one heat pipe are respectively mounted to correspond to each line of light emitting diodes.

Conventionally, since the plurality of light emitting diodes of one line are arranged in a horizontal direction, the heat pipe is also mounted in the horizontal direction in the direct light type backlight system. The heat pipe is a two-phase heat transfer mechanism having a working fluid circuit between an evaporator where a working fluid evaporates removing heat from a surrounding environment and a condenser where the working fluid liquefies releasing the heat.

When the heat pipe is mounted in the horizontal direction, the performance of the heat pipe may be deteriorated. In other words, the heat pipe removes heat using the working fluid circuit to obtain a cooling effect. When the heat pipe is mounted in the horizontal direction, the working fluid liquefied in the condenser returns to the evaporator through a wick, i.e., the circulation of working fluid is not smooth, so that the heat pipe does not operate correctly.

When the heat pipe does not effectively remove the heat generated by the light emitting diodes, its performance deteriorates thereby lowering the brightness of the backlight and/or varying the color. Accordingly, the backlight system needs to be improved so that the heat generated from the plurality of light emitting diodes can be effectively removed.

### SUMMARY OF THE INVENTION

The present general inventive concept provides a direct light type backlight system and an LCD employing the same in which an arrangement of light emitting devices and an arrangement of at least one heat pipe are improved to effectively remove heat generated by the light emitting diodes (LEDs) or the like.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a backlight system usable in a display positionable in an upright manner, including a plurality of light emitting device arrangement lines, each line including a plurality of light emitting devices and a plurality of heat pipes each mounted along one of the plurality of light emitting device arrangement lines, wherein each of the plurality of light emitting device arrangement lines and the corresponding mounted heat pipe form a predetermined angle with respect to a horizontal direction such that a movement of working fluid condensed in the heat pipe is accelerated by gravity.

The backlight system may further comprise a base plate, and a plurality of substrates on which the plurality of light emitting devices of one of the plurality of light emitting device arrangement lines may be arranged in a line, wherein the plurality of substrates mounted with the plurality of light emitting devices in the line may be installed on the base plate to form the plurality of light emitting device arrangement lines.

The predetermined angle may be one of a right angle with respect to the horizontal direction and an inclination angle with respect to the horizontal direction.

The backlight system may further include a plurality of heat sinks each corresponding to one of the plurality of light emitting device arrangement lines and mounted at an end of the corresponding mounted heat pipe.

The backlight system may further comprise a circuit part to drive the plurality of light emitting devices disposed adjacent to one side of the plurality of light emitting device arrangement lines, wherein the plurality of heat sinks may partially overlap the plurality of light emitting device arrangement lines except for an area where the circuit part is positioned.

Each heat pipe may overlap an upper surface of the corresponding light emitting device arrangement line.

Each heat pipe may be disposed between a corresponding one of the plurality of light emitting device arrangement lines and the corresponding heat sink.

The backlight system may further include a plurality of cooling fans each corresponding to one of the plurality of light emitting device arrangement lines.

Each of the plurality of light emitting devices may include a light emitting diode chip to emit light and a collimator to collimate the light emitted by the light emitting diode chip.

The collimator may be one of a side emitter to direct incident light to propagate in a lateral direction and a dome-shaped collimator.

The foregoing and/or other aspects of the present general inventive concept may also be achieved by providing an LCD including a liquid crystal panel, and a backlight system to illuminate the liquid crystal panel positionable in a upright manner, the backlight system including a plurality of light emitting device arrangement lines, each line including a plurality of light emitting devices, and a plurality of heat pipes each mounted along one of the plurality of light emitting device arrangement lines, wherein each of the plurality of light emitting device arrangement lines and the corresponding mounted heat pipe form a predetermined angle with respect to a horizontal direction such that a movement of a working fluid condensed in the corresponding mounted heat pipe is accelerated by gravity.

The foregoing and/or other aspects of the present general inventive concept may also be achieved by providing a backlight system usable with a display, the backlight system comprising a plurality of light emitting devices disposed on a line, and a heat pipe disposed along the line, containing a working fluid, having an evaporation part formed in a lengthwise direction of the line, and having a condensation part disposed in an upper end of the heat pipe.

The foregoing and/or other aspects of the present general inventive concept may also be achieved by providing a liquid crystal display comprising a panel to display images according to an input image signal, and a backlight unit to illuminate the panel.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a view illustrating an array of light emitting devices of a backlight system according to an embodiment of the present general inventive concept;

FIG. 2 is a view of a backlight system on a side opposite to a liquid crystal panel when a plurality of light emitting devices are arranged as illustrated in FIG. 1;

FIG. 3 is a side view of a backlight system according to an embodiment of the present general inventive concept;

FIG. 4 is a partial detailed front view of a backlight system according to an embodiment of the present general inventive concept;

FIG. 5 is a view illustrating an array of light emitting devices of a backlight system according to another embodiment of the present general inventive concept;

FIG. 6 is a detailed view of a light emitting device included in the backlight system in FIGS. 3 and 4 according to an embodiment of the present general inventive concept;

FIG. 7 illustrates a direct light type backlight system according to an embodiment of the present general inventive concept;

FIG. 8 illustrates a direct light type backlight system according to another embodiment of the present general inventive concept;

FIG. 9 is a view of an LCD employing a backlight system according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

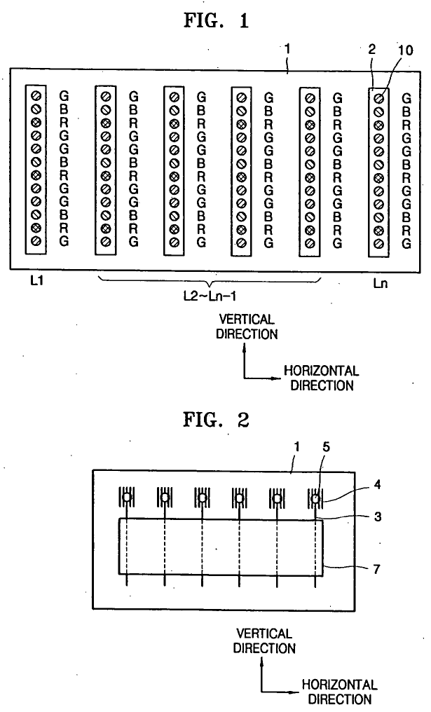

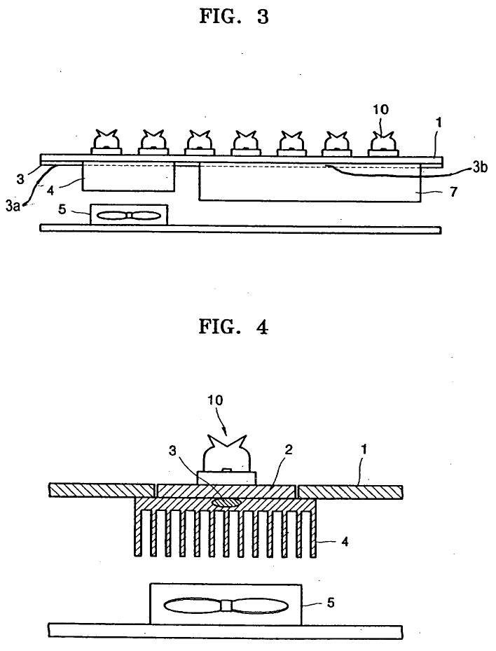

FIG. 1 is a view illustrating an array of light emitting devices 10 of a backlight system according to an embodiment of the present general inventive concept. FIG. 2 is a view of a backlight system on a side opposite to a liquid crystal panel when a plurality of light emitting devices 10 are arranged as illustrated in FIG. 1. FIG. 3 is a side view of a backlight system according to an embodiment of the present general inventive concept, and FIG. 4 is a detailed front view of a backlight system according to an embodiment of the present general inventive concept.

Referring to FIGS. 1 to 4, the backlight system includes a plurality of light emitting device arrangement lines L1-Ln disposed on a base plate 1, each arrangement line including a plurality of light emitting devices 10, and a plurality of heat pipes 3 mounted along the plurality of light emitting device arrangement lines L1-Ln. The plurality of light emitting device arrangement lines L1-Ln and the heat pipes 3 are arranged such that a movement of a working fluid condensed in the heat pipes 3 is accelerated by gravity. Also, the backlight system may further include heat sinks 4 arranged to correspond to the plurality of light emitting device arrangement lines L1-Ln and a circuit part 7 connected to the plurality of light emitting devices 10. In addition, the backlight system may further include cooling fans 5 mounted at positions corresponding to the plurality of light emitting device arrangement lines L1-Ln.

In the backlight system according to one embodiment of the present general inventive concept, the plurality of light emitting device arrangement lines L1-Ln can be obtained by mounting two or more substrates 2 on the base plate 1 in two or more lines, each substrate 2 including the plurality of light emitting devices 10 arranged in a line. The plurality of light emitting device arrangement lines L1-Ln form a two-dimensional array of light emitting devices over an area. Each substrate 2 including the plurality of light emitting devices 10 corresponds to each of light emitting device arrangement lines L1-Ln. FIGS. 1 and 2 exemplarily illustrate six light emitting device arrangement lines L1-L6 (that is, here n is 6).

Each of the plurality of light emitting device arrangement lines L1-Ln form an angle with respect to a horizontal direction as will be described below, and the plurality of light emitting device arrangement lines L1-Ln are parallel to one another. Since a general display has a screen size ratio of 4:3 or 16:9, a horizontal dimension (width) of the backlight system of the present embodiment may be larger than a vertical dimension (height). When the present general inventive concept is applied to a display that has a vertical dimension that is larger than a horizontal dimension, the relative arrangement of the backlight system illustrated in the present embodiment may be changed.

Each of the substrates 2 may be a printed circuit board (PCB) mounted to be electrically connected to each light emitting device chip of the light emitting devices 10, for example, a metal core PCB (MCPCB).

As described above, by mounting two or more substrates 2 each including the plurality of light emitting devices 10 arranged in a line on the base plate in two or more lines, the plurality of light emitting device arrangement lines L1-Ln illustrated in FIG. 1 can be obtained.

In order for the working fluid condensed in the heat pipes 3 to move due to gravity, a direction along which the heat pipes 3 are mounted should include a vertical direction component corresponding to the gravity direction. The heat pipes 3 should be mounted such that a condensation part 3a where the vaporized working fluid is condensed is positioned in an upward direction, that is, the condensation part 3a is disposed on an upper portion of the heat pipes 3. For example, the heat pipes 3 includes a first end corresponding to the cooling fan 5 and a second end opposite to the first end, and the condensation part 3a is disposed on the first end. The evaporation part 3b is formed in a lengthwise direction of each of the plurality of light emitting devices arrangement lines.

As described above, the plurality of light emitting device arrangement lines L1-Ln are arranged at an angle with respect to the horizontal direction perpendicular to the direction of gravity, for example, a right angle or an inclination angle. The heat pipes 3 are mounted along the plurality of light emitting device arrangement lines L1-Ln such that a movement of the working fluid condensed in the heat pipes 3 is accelerated due to gravity. As illustrated in FIG. 4, the heat pipes 3 may be mounted on surfaces of the substrates 2 opposite to surfaces on which the plurality of light emitting device arrangement lines L1-Ln are arranged, or on a lower surface of the base plate 1 opposite to an upper surface on which the plurality of light emitting device arrangement lines L1-Ln are disposed.

The horizontal direction, perpendicular to the direction of gravity, corresponds to a horizontal scanning direction of the display, and the vertical direction, perpendicular to the horizontal direction, corresponds to the direction of gravity or the opposite direction of gravity. However, it should be understood that these directions are merely reference directions used for illustration purposes, and are not meant to limit the scope of the present general inventive concept. In a display using the backlight system as an illumination source, for instance, an LCD may be used in an upright position, and the horizontal scanning direction of the LCD may be substantially parallel to a ground surface, and the direction perpendicular to the horizontal scanning direction may become the vertical scanning direction.

As described above, if the plurality of light emitting device arrangement lines L1-Ln have a predetermined angle with respect to the horizontal direction, for example, a right angle or an inclination angle, the heat pipes 3 arranged along the plurality of light emitting device arrangement lines L1-Ln form the predetermined angle with respect to the horizontal direction.

The plurality of light emitting device arrangement lines L1-Ln may form the predetermined angle with respect to the horizontal direction within a plane including the horizontal direction and the vertical direction, or may form the predetermined angle with respect to a plane that is parallel to the horizontal direction and is perpendicular to the vertical direction.

FIGS. 1 through 4 illustrate that the plurality of light emitting device arrangement lines L1-Ln form the right angle with respect to the horizontal direction and the heat pipes 3 form a substantially right angle with respect to the horizontal direction.

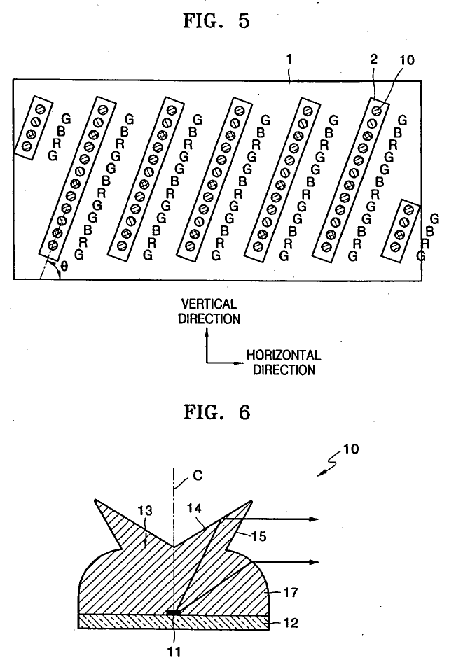

Alternatively, the plurality of light emitting device arrangement lines L1-Ln may form an inclination angle θ with respect to the horizontal direction as illustrated in FIG. 5. In this case, the heat pipes 3 also form the inclination angle θ with respect to the horizontal direction. Since the installation direction of the heat pipes 3 has a component that is perpendicular to the horizontal direction, movement of the condensed working fluid can be accelerated by gravity.

As described above, the heat pipes 3 may be arranged along the plurality of light emitting device arrangement lines L1-Ln such that the heat generated from the LED chips is effectively radiated. Since the plurality of light emitting device arrangement lines L1-Ln form the predetermined angle with respect to the horizontal scanning direction, (e.g. the right angle or the inclination angle), the heat pipes 3 also form substantially the same predetermined angle with respect to the horizontal scanning direction, (e.g. a substantially right angle or an angle substantially equal to the inclination angle), so that the movement of the working fluid condensed in the heat pipes 3 can be accelerated by gravity. In other words, the working fluid liquefied by condensation can descend more rapidly due to gravity.

Accordingly, the working fluid can be smoothly circulated inside the heat pipes 3, and the heat pipes 3 can maintain temperature uniformity around the LED chips of the plurality of light emitting devices 10 in one line.

The heat pipe 3 includes the evaporation part 3b, an adiabatic part (not shown), and the condensation part 3a. When heat is applied to the evaporation part 3b, working fluid is vaporized and moves to the condensation part 3a and a working fluid circuit is closed through the adiabatic part, and the vaporized working fluid is liquefied in the condensation part and returns to the evaporation part through a wick. By circulating the working fluid, the heat generated by the LED chips of the plurality of light emitting devices 10 and by the circuit part 7 is removed. Thus, the heat pipes 3 remove heat through circulation of working fluid, thereby obtaining a cooling effect.

In the backlight system of the present embodiment, since the heat pipes 3 are mounted at the predetermined angle with respect to the horizontal direction such that gravity accelerates the movement of the working fluid, the return of the working fluid liquefied in the condensation part to the evaporation part through the wick can be smoothly performed. Accordingly, the heat pipes 3 can effectively remove the heat generated by the LED chips, so that deterioration in brightness and variation in color of the LCD are prevented.

Each of the heat pipes 3 may extend along a length of each of the light emitting device arrangement lines L1-Ln. The heat pipes 3 may be disposed between each of the light emitting device arrangement lines L1-Ln and corresponding the heat sinks 4. By forming the light emitting device arrangement lines L1-Ln at the right angle or the inclination angle θ with respect to the horizontal direction, the heat pipes 3 are mounted such that their condensation parts are positioned in the upward direction. At this time, the evaporation parts of the heat pipes 3 are distributed over an entire area. The working fluid converted into liquid in the condensation part 3a of the heat pipe 3 again moves to the evaporation part 3b through the wick. In this case, the working fluid can move downwards with the help of a force of gravity.

The circuit part 7 drives the plurality of light emitting devices 10, and may be mounted on a lower surface of the base plate 1 as illustrated in FIGS. 2 through 4.

As illustrated in FIGS. 2 and 3, if the circuit part 7 is mounted on the lower surface of the base plate 1, the heat sinks 4 may be arranged to partially overlap ends of the light emitting device arrangement lines L1-Ln except for an area occupied by the circuit part 7.

However, since the area occupied by the circuit part 7 that is not covered by the heat sinks 4 includes the heat pipes 3, the LED chips of the light emitting devices 10 on each of the light emitting device arrangement lines L1-Ln can maintain a uniform temperature.

Thus, by not overlapping the circuit part 7 with the heat sinks 4, it is possible to decrease the thickness the backlight system.

Cooling fans 5 may be disposed at positions corresponding to the light emitting device arrangement lines L1-Ln. One cooling fan 5 blows air into a corresponding heat sink 4 in a direction parallel to fins of each of the heat sinks 4, thereby dissipating heat accumulated in the heat sinks 4. For example, although a temperature difference between a first light emitting device arrangement line L1 and a second light emitting device arrangement line L2 exists, the temperature difference may be decreased by changing a velocity of the corresponding cooling fans 5 mounted on each line.

On each of the light emitting device arrangement lines L1-Ln, one heat pipe 3, one heat sink 4 and one cooling fan 5 can be mounted.

The heat sink 4 and/or the cooling fan 5 may be mounted in an upward direction such that they are positioned on the condensation parts of the heat pipes 3.

In other words, in the backlight system of the present embodiment, the heat pipes 3 are mounted at the right angle or the inclination angle θ with respect to the horizontal direction, and the heat pipes 3 may be mounted on the base plate 1 or the substrates 2 having the light emitting devices 10 mounted thereon such that the condensation parts of the heat pipes 3 are positioned in upper portions of the heat pipes 3 and the heat sinks 4 and the cooling fans 5 may be mounted near the condensation parts of the heat pipes 3.

Although FIGS. 1 through 5 illustrate that two or more substrates 2 each having the plurality of light emitting devices 10 arranged in a line are mounted on the base plate 1 in two or more lines, it should be understood that other arrangements may be used. For example, the light emitting device arrangement lines L1-Ln may be formed by mounting the plurality of light emitting devices 10 directly on the base plate 1 in two or more lines. In this case, the base plate 1 may be provided with a printed circuit board (PCB), for example, a metal core PCB (MCPCB) mounted to electrically connect the LED chips of the plurality of light emitting devices 10. In this case, the light emitting device arrangement lines L1-Ln may be formed at a predetermined angle with respect to the horizontal scanning direction.

FIG. 6 is a detailed view of the light emitting device 10. As illustrated in FIG. 6, each light emitting device 10 may include a light emitting diode chip 11 to emit light, and a collimator to collimate light emitted by the light emitting diode chip 11. The collimator may include a side emitter 13 to direct incident light to propagate toward an approximate side direction.

The light emitting diode chip 11 can be coupled with the side emitter 13 on a base 12.

The side emitter 13 may be closely in contact with the light emitting diode chip 11 so that an amount of light from the light emitting diode chip 11 incident into the side emitter 13 can be maximized.

The plurality of light emitting devices 10 can be provided to emit red (R), green (G) and blue (B) lights. The R, G and B light emitting diode chips 11 are respectively used for the R, G and B light emitting devices 10. The plurality of light emitting devices 10 emitting R, G and B lights may be arranged to alternate along each line.

Numbers of the R, G and B light emitting devices 10 in each line may be equal to each other or may be different depending on amounts of R, G and B light emitted from each of the R, G and B light emitting devices 10.

The amounts of R, G and B light emitted from the R, G and B LED chips 11 may be different. For example, the amount of G light emitting from a G LED chip 11 may be less than the amount of R and B light emitted from an R and a B LED chips 11. Considering the possible difference in the amount of emitted light of each color, for example, as illustrated in FIGS. 1 and 5, same number of R and B light emitting devices 10 may be arranged along each line and twice as many G light emitting devices may be arranged along each line. Additionally, the R, G and B light emitting devices 10 may be arranged, for example, in a sequence of R, G, G and B or in a sequence of B, G, G and R.

Alternatively, the light emitting devices 10 may emit all white light. In this case, LED chips 11 each emitting white light may be employed in the light emitting devices 10.

In both cases, LED chips 11 emitting R, G and B lights or LED chips 11 emitting white light, an LCD employing a backlight system according to the present embodiment can display color images.

Referring to FIG. 6, the side emitter 13 has a transparent body which may be made of a transparent material. For example, the side emitter 13 may include a reflection surface 14 shaped as a funnel inclined with respect to a central axis (C) of the light emitting device 10, a first refraction surface 15 inclined with respect to the central axis (C) to refract and transmit light that is reflected by the reflection surface 14 and is then incident thereon, and a second refraction surface 17 extending from the base 12 to the first refraction surface 15 and having a convex shape. Light emitted from the LED chip 11 may propagate toward the reflection surface 14 of the side emitter 13 and may then be reflected on the reflection surface 14. The reflected light propagates toward the first refraction surface 15, is transmitted through the first refraction surface 15, and then may then propagate in a lateral direction. Also, light emitted from the light emitting diode chip 11 may propagate toward the convex second refraction surface 17, may then be transmitted through the second refraction surface 17 and may then propagate in the lateral direction.

The side emitter 13 may have other various shapes to emit the light incident from the light emitting diode chip 11 in the lateral direction.

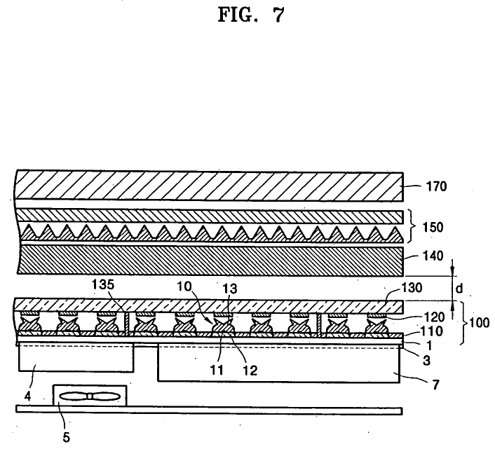

FIG. 7 schematically illustrates a direct light type backlight system according to an embodiment of the present general inventive concept. In the following description, for convenience, relative positions of components of the present embodiment are defined with reference to a vertical direction towards a liquid crystal display panel positioned above the backlight system. However, it should be understood that this description is not intended to limit the scope of the present general inventive concept and is merely exemplary.

Referring to FIG. 7, the backlight system includes a light reflection diffusion plate 110 disposed below the plurality of light emitting devices 10 to diffuse and reflect incident light, and a light transmission diffusion plate 140 disposed above the plurality of light emitting devices 10 to diffuse and transmit incident light.

The light reflection diffusion plate 110 diffuses and reflects the incident light such that the incident light travels toward the liquid crystal panel (upwards in FIG. 7). The light reflection diffusion plate 110 is disposed on the base plate 1 below the plurality of light emitting devices 10. The light reflection diffusion plate 110 may have a plurality of holes through which the plurality of light emitting devices 10 are disposed. Accordingly, the diffusion plate 110 is mounted on the base plate 1 after the light emitting device units 10 are inserted into the holes.

The light transmission diffusion plate 140 is positioned spaced apart by a predetermined distance from a lower portion 100 of the backlight system, at a separation distance ‘d.’ The light transmission diffusion plate 140 diffuses and transmits incident light.

If the light transmission diffusion plate 140 is too close to the light emitting devices 10, areas where the light emitting devices 10 are positioned appear brighter than areas in-between the light emitting devices 10 (i.e. areas where the light emitting devices 10 are not positioned), so that uniformity in brightness may be deteriorated. Also, the larger the separation distance ‘d’ between the light transmission diffusion plate 140 and the light emitting device units 10, the thicker the backlight system is. Accordingly, the separation distance ‘d’ between the light transmission diffusion plate 140 and the lower portion 100 of the backlight system including the light emitting devices 10 is set to a minimum value so that lights can be sufficiently mixed to provide a uniform brightness by light diffusion.

Most light emitted from the light emitting diode chip 11 of the light emitting device 10 propagates toward the lateral direction due to the side emitter 13, however, light may also pass through the reflection surface 14 of the side emitter 13 and propagate towards the liquid crystal panel (in an upward direction in FIG. 7). An amount of the light propagating through the side emitter 13 directly towards the liquid crystal panel may be, for example, about 20% of a total amount of light emitted by the light emitting diode chip 11.

The light propagating through the side emitter 13 directly towards the liquid crystal panel causes a bright spot or a bright line to appear above the light emitting diode chip 11. Also, when using R, G and B LED chips 11 emitting R, G and B light emitting devices 10 colored spots or colored lines may appear.

Therefore, the backlight system of the present embodiment of the general inventive concept may be further provided with a plurality of reflection mirrors 120 formed on a surface of an optical plate 130, to reflect light emitted by the plurality of light emitting devices 10 directly towards the liquid crystal panel. The plurality of reflection mirrors 120 may be formed in an array on a surface of the optical plate 130 to correspond to an array of the plurality of light emitting devices 10 such that the plurality of reflection mirrors 120 are disposed above the corresponding plurality of light emitting devices 10. The reflection mirrors 120 may reflect light back into the side emitter 13 (downward in FIG. 7).

The optical plate 130 having the plurality of reflection mirrors 120 may be formed of transparent polymethyl-methacrylate (PMMA) to transmit incident light. Alternatively, the optical plate 130 may be a light transmission diffusion plate (i.e. a second light transmission diffusion plate).

The plurality of reflection mirrors 120 may be spaced apart from the light emitting devices 10 at a predetermined distance. To maintain the predetermined distance between the plurality of reflection mirrors 120 and the light emitting devices 10, the optical plate 130 may be supported by a supporting bar 135. The supporting bar 135 supports the optical plate 130 with respect to the light reflection diffusion plate 110 or the base plate 1.

When the optical plate 130 is a light transmission diffusion plate, the incident light can be diffused sufficiently compared to when the backlight system only has the light reflection diffusion plate 110 and the light transmission diffusion plate 140, so that the separation distance ‘d’ between the light transmission diffusion plate 140 and the lower portion 100 of the backlight having the light emitting devices 10 can be reduced. The reduction of the separation distance ‘d’ results in a decrease in the thickness of the backlight system.

When the optical plate 130 is a light transmission diffusion plate (i.e. the second light transmission diffusion plate), light transmittance may decrease compared with when the optical plate 130 is the transparent PMMA. Accordingly, whether the optical plate 130 is the light transmission diffusion plate or the transparent PMMA depends on whether a design is focused on maximizing light transmittance or minimizing the thickness of the backlight system.

The backlight system of the present embodiment may further be provided with a brightness enhancement film (BEF) 150 to enhance a directivity of light emitted from the light transmission diffusion plate 140. Additionally, the backlight system may further be provided with a polarization enhancement film 170 to enhance a polarization efficiency.

The BEF 150 refracts and focuses the light emitted from the light transmission diffusion plate 140 to enhance the directivity of the light, thereby enhancing brightness.

The polarization enhancement film 170, for example, transmits p-polarized light but reflects s-polarized light, so that most of the incident light has one polarization state, for example, p-polarized state, after passing through the polarization enhancement film 170.

In the LCD employing the backlight system, a liquid crystal panel is illuminated by the backlight system. The liquid crystal panel receives light linearly polarized in one state to be incident into a liquid crystal layer of the liquid crystal panel and changes a direction of a liquid crystal director by applying an electric field to change the polarization direction of the light passing through the liquid crystal layer, thereby displaying image information.

Accordingly, if the light incident into the liquid crystal panel predominantly has a single polarization, a light usage efficiency is enhanced. By providing the polarization enhancement film 170 in the backlight system, the light usage efficiency may be enhanced.

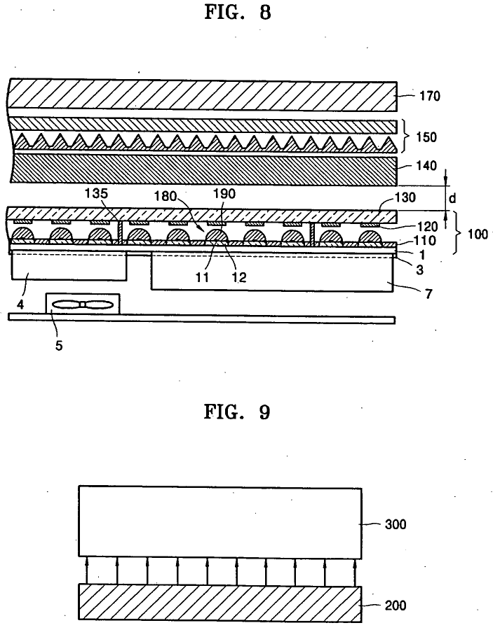

Although the above embodiments illustrate and describe that the backlight system of the present general inventive concept is provided with the light emitting device units 10 having the side emitter 13 to function as a collimator, the backlight system may alternatively be provided with a plurality of light emitting devices 180 each having a dome-shaped collimator 190 as illustrated in FIG. 8. FIG. 8 illustrates a direct light type backlight system according to another embodiment of the present general inventive concept. The backlight system illustrated in FIG. 8 has substantially the same components as the above embodiment except for the plurality of light emitting devices 180, each having the dome-shaped collimator 190.

FIG. 9 is a view illustrating an LCD employing a backlight system according to an embodiment of the present general inventive concept.

Referring to FIG. 9, the LCD includes a backlight system 200 and a liquid crystal panel 300 illuminated by the backlight system 200. The backlight system 200 can be a backlight system as described in the above embodiments. The liquid crystal panel 300 is connected with a driving circuit part.

As described above, in a backlight system and an LCD employing the backlight system according to various embodiments of the present general inventive concept, an arrangement of light emitting devices and an arrangement of heat pipes are improved, effectively removing heat generated by the light emitting devices. Accordingly, deterioration in brightness or alteration in color are prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A backlight system usable in a display positionable in an upright manner, the backlight system comprising:
a plurality of light emitting device arrangement lines, each line including a plurality of light emitting devices; and
a plurality of heat pipes each mounted along one of the plurality of light emitting device arrangement lines,
wherein each of the plurality of light emitting device arrangement lines and the corresponding mounted heat pipe form a predetermined angle with respect to a horizontal direction such that a movement of a working fluid condensed in the corresponding mounted heat pipe is accelerated by gravity.

2. The backlight system of claim 1, further comprising:
a base plate; and
a plurality of substrates on which the plurality of light emitting devices of one of the plurality of light emitting device arrangement lines are arranged in a line,
wherein the plurality of substrates mounted with the plurality of light emitting devices in the line are installed on the base plate to form the plurality of light emitting device arrangement lines.

3. The backlight system of claim 1, wherein the predetermined angle is one of a right angle with respect to the horizontal direction and an inclination angle with respect to the horizontal direction.

4. The backlight system of claim 1, further comprising:
a plurality of heat sinks each corresponding to one of the plurality of light emitting device arrangement lines and mounted at an end of the corresponding mounted heat pipe.

5. The backlight system of claim 4, further comprising:
a circuit part to drive the plurality of light emitting devices disposed adjacent to one side of the plurality of light emitting device arrangement lines,
wherein the plurality of heat sinks partially overlap the plurality of light emitting device arrangement lines except for an area where the circuit part is positioned.

6. The backlight system of claim 5, wherein each heat pipe overlaps an entire upper surface of the corresponding light emitting device arrangement line.

7. The backlight system of claim 4, wherein each heat pipe is disposed between a corresponding one of the plurality of light emitting device arrangement lines and the corresponding heat sink.

8. The backlight system of claim 4, further comprising:
a plurality of cooling fans each corresponding to one of the plurality of light emitting device arrangement lines.

9. The backlight system of claim 1, wherein each of the plurality of light emitting devices comprises:
a light emitting diode chip to emit light; and
a collimator to collimate the light emitted by the light emitting diode chip.

10. The backlight system of claim 9, wherein the collimator is one of a side emitter to direct incident light to propagate in a lateral direction and a dome-shaped collimator.

11. An LCD, comprising:
a liquid crystal panel; and
a backlight system to illuminate the liquid crystal panel, and positionable in a upright manner, the backlight system including:
a plurality of light emitting device arrangement lines, each line including a plurality of light emitting devices; and
a plurality of heat pipes each mounted along one of the plurality of light emitting device arrangement lines,
wherein each of the plurality of light emitting device arrangement lines and the corresponding mounted heat pipe form a predetermined angle with respect to a horizontal direction such that a movement of a working fluid condensed in the corresponding mounted heat pipe is accelerated by gravity.

12. The LCD of claim 11, further comprising:
a base plate; and
a plurality of substrates on which the plurality of light emitting devices of one of the plurality of light emitting device arrangement lines are arranged in a line,
wherein the plurality of substrates mounted with the plurality of light emitting devices in the line are installed on the base plate to form the plurality of light emitting device arrangement lines.

13. The LCD of claim 11, wherein the predetermined angle is one of a right angle with respect to the horizontal direction and an inclination angle with respect to the horizontal direction.

14. The LCD of claim 11, further comprising:
a plurality of heat sinks each corresponding to one of the plurality of light emitting device arrangement lines and mounted at an end of the corresponding mounted heat pipe.

15. The LCD of claim 14, further comprising:
a circuit part to drive the plurality of light emitting devices disposed adjacent to one side of the plurality of light emitting device arrangement lines,
wherein the plurality of heat sinks partially overlap the plurality of light emitting device arrangement lines except for an area where the circuit part is positioned.

16. The LCD of claim 15, wherein the plurality of heat pipe overlaps an area of the plurality of light emitting device arrangement lines.

17. The LCD of claim 14, wherein the heat pipe is disposed between the plurality of light emitting device arrangement lines and the corresponding heat sinks.

18. The LCD of claim 14, further comprising:
a plurality of cooling fans each corresponding to one of the plurality of light emitting device arrangement lines.

19. The LCD of claim 11, wherein each of the plurality of light emitting devices comprises:
a light emitting diode chip to emit light; and
a collimator to collimate the light emitted by the light emitting diode chip.

20. The LCD of claim 19, wherein the collimator is one of a side emitter to direct incident light to propagate in a lateral direction and a dome-shaped collimator.

21. A backlight system usable with a display, the backlight system comprising:
a plurality of light emitting devices disposed on a line; and
a heat pipe disposed along the line, containing a working fluid, having an evaporation part formed in a lengthwise direction of the line, and having a condensation part disposed in an upper end of the heat pipe.

22. The backlight system of claim 21, wherein the working fluid condensed in the condensing part descends to a lower end of the heat pipe by gravity.

23. A liquid crystal display, comprising:
a panel to display images according to an input image signal; and
a backlight unit to illuminate the panel, comprising:
a plurality of light emitting devices disposed on a line; and
a heat pipe disposed along the line, containing a working fluid, having an evaporation part formed in a lengthwise direction of the line, and having a condensation part disposed in an upper end of the heat pipe.

24. The liquid crystal display of claim 23, wherein the working fluid condensed in the condensation part descends to a lower end of the heat pipe by gravity.

25. The backlight system of claim 24, wherein the panel is disposed in a vertical direction corresponding to a direction of the gravity, and the lengthwise direction corresponds to the direction of the gravity.

26. The backlight system of claim 24, wherein the panel is disposed in a direction having a first angle with a direction of the gravity, and the lengthwise direction forms a second angle with the direction of the gravity.
